(19) United States
(12) Patent Application Publication
(10) Pub. No.: US 2007/0033861 A1
(43) Pub. Date: Feb. 15, 2007

(54) Method for water-in-hydrocarbon emulsion fuel cell reformer start-up

(76) Inventors: Ramesh Varadaraj, Flemington, NJ (US); Paul Joseph Berlowitz, Glen Gardner, NJ (US)

Correspondence Address: MARK D. MARIN;NORRIS, McLAUGHLIN & MARCUS, P.A., 875 THIRD AVE. 18TH FLOOR, NEW YORK, NY, 10022, US

(21) Appl. No.: 11/581,924

(22) Filed: Oct. 17, 2006

Related U.S. Application Data
(63) Continuation-in-part of application No. 10/324,211, filed on Dec. 20, 2002, now abandoned.
(60) Provisional application No. 60/352,029, filed on Jan. 25, 2002.

(51) Int. Cl. C11D 17/00; C10L 1/32; C11D 17/08

(52) U.S. Cl. 44/301; 510/417

(57) ABSTRACT

The present invention relates to water-in-hydrocarbon emulsion compositions comprising hydrocarbon fuel, water and alkoxylated branched alkyl alcohol surfactants for starting a reformer of a fuel cell system. A method to prepare a water in-hydrocarbon emulsion comprises preparing a first mixture of hydrocarbon-in-water emulsion and excess hydrocarbon, preparing a second mixture of water-in-hydrocarbon emulsion and excess water, adding the said first mixture of hydrocarbon-in-water emulsion and excess hydrocarbon to said second mixture of water-in-hydrocarbon emulsion and excess water and then mixing said first and second mixtures to form the water-in-hydrocarbon emulsion. The present invention utilizes substantially less surfactant and mixing times for the formation of the emulsion, a commercially important feature.

### CROSS REFERENCE TO RELATED APPLICATION

This application is a Continuation-In-Part of U.S. Ser. No. 10/324,211 filed Dec. 20, 2002.

This application is a Continuation-In-Part of U.S. Ser. No. 10/324,211 filed Dec. 20, 2002.

The present invention relates to compositions for use at start-up a reformer of a fuel cell system. In particular, this invention includes emulsion compositions comprising hydrocarbon fuel, water and surfactant for use at start-up of a reformer of a fuel cell system.

Fuel cell systems employing a partial oxidation, steam reformer or autothermal reformer or combinations thereof to generate hydrogen from a hydrocarbon need to have water present at all times to serve as a reactant for reforming, water-gas shift, and fuel cell stack humidification. Since water is one product of a fuel cell stack, during normal warmed-up operation, water generated from the fuel cell stack may be recycled to the reformer. For start-up of the reformer it is preferable that liquid water be well mixed with the hydrocarbon fuel and fed to the reformer as an emulsion. The current invention provides emulsion compositions suitable for use at start-up of a reformer of a fuel cell system.

### SUMMARY OF THE INVENTION

One embodiment of the invention provides an improved water-in-hydrocarbon emulsion composition suitable for use at start-up of a reformer of a fuel cell system comprising hydrocarbon, water and surfactant.

In one embodiment, the invention is a method to prepare a product water-in-hydrocarbon emulsion comprising preparing a first mixture of a hydrocarbon-in-water emulsion and excess hydrocarbon, preparing a second mixture of a water-in-hydrocarbon emulsion and excess water, adding the first mixture of hydrocarbon-in-water emulsion and excess hydrocarbon to the second mixture of water-in-hydrocarbon emulsion and excess water, and then mixing the first and second mixtures to form the product water-in-hydrocarbon emulsion. The method substantially reduces the amount of surfactant and mixing times required to form the product water-in-hydrocarbon emulsion.

Another embodiment is a fuel cell system having a reformer and water gas shift reactor operably connected to a fuel cell stack wherein hydrocarbon and steam are fed to the reformer to produce water gas for conversion in the reactor to a hydrogen containing gas for use in the fuel cell stack, the improvement comprising feeding to the reformer, at start-up a product water-in-hydrocarbon emulsion wherein said product water-in-hydrocarbon emulsion is made by:

a) preparing a first mixture of hydrocarbon-in-water emulsion and excess hydrocarbon,

b) preparing a second mixture of water-in-hydrocarbon emulsion and excess water,

c) adding the said first mixture of hydrocarbon-in-water emulsion and excess hydrocarbon to said second mixture of water-in-hydrocarbon emulsion and excess water and then mixing said first and second mixtures to form the said product water-in-hydrocarbon emulsion.

### DETAILED DESCRIPTION OF THE PREFERRED EMBODIMENTS

The product water-in-hydrocarbon emulsion compositions of the present invention can be used for start-up of a reformer of a fuel cell system. The term “product water-in-hydrocarbon emulsion” means an emulsion formed by the combined water-in-hydrocarbon emulsion with the hydrocarbon-in-water emulsion as taught herein. In a preferred embodiment the product water-in-hydrocarbon emulsion composition is used for start-up of a reformer of “advanced” fuel cell systems such as those described in U.S. Pat. No. 6,736,867 and U.S. Pat. No. 7,081,143. The “advanced” fuel cell system comprises a conventional fuel cell system to which a start-up system is operably connected.

Among the desirable features of emulsions suitable for use in the improved fuel cell start-up system described above are: (a) the ability to form emulsions at low shear; (b) the ability of the surfactants to decompose at temperatures below 700° C.; (c) the viscosity of the emulsions being such that they are easily pumpable. The product water-in-hydrocarbon emulsions of the instant invention possess these and other desirable attributes.

Once the reformer is started with the product water-in-hydrocarbon emulsion composition it can continue to be used for a time period until a switch is made to a hydrocarbon and steam composition. Typically a start-up time period can range from 0.5 minutes to 30 minutes depending upon the device the fuel cell system is the power source of. The product water-in-hydrocarbon emulsion composition of the instant invention comprises hydrocarbon, water and surfactant. In a preferred embodiment the product water-in-hydrocarbon emulsion further comprises low molecular weight alcohols. The product water-in-hydrocarbon emulsion is made by preparing a first mixture of hydrocarbon-in-water emulsion and excess hydrocarbon, preparing a second mixture of water-in-hydrocarbon emulsion and excess water, adding the first mixture of hydrocarbon-in-water emulsion and excess hydrocarbon to the second mixture of water-in-hydrocarbon emulsion and excess water, and then mixing the first and second mixtures to form the product water-in-hydrocarbon emulsion.

Applicants have found that the method of forming a product water-in-hydrocarbon emulsion by mixing two mixtures i.e., a first mixture of hydrocarbon-in-water emulsion and excess hydrocarbon, with a second mixture of water-in-hydrocarbon emulsion and excess water is advantageous for many applications, particularly as feed for a fuel cell reformer. The advantage being that the resultant product is a water-in-hydrocarbon emulsion with substantially no excess phase separated water or hydrocarbon. Further, the resultant water-in-hydrocarbon emulsion is a macro emulsion. While not wishing to be bound to the manner in which such a product water-in-hydrocarbon is formed, applicants believe that the disclosed method inverts the oil-in-water emulsion to a water-in-oil emulsion with simultaneous increase in water uptake. The new and novel method of making the product water-in-hydrocarbon emulsion of the instant invention has the advantage that lesser surfactant is required to make the product water-in-hydrocarbon emulsion compared to known methods of making a water-in-hydrocarbon emulsion. When compared to known methods such as adding surfactant to a mixture of hydrocarbon and water and mixing, the present invention uses substantially less surfactant, typically fifty (50%) percent less. The present invention also uses less mixing energy to successfully form the emulsion, relative to the prior art. Thus, the method of mixing two emulsions of opposite continuity to form a product emulsion of hydrocarbon continuity is novel and advantageous in providing a solution to the long standing problem of minimizing surfactant amounts in making emulsions.

A hydrocarbon-in-water emulsion is one where hydrocarbon droplets are dispersed in water. A water-in-hydrocarbon emulsion is one where water droplets are dispersed in hydrocarbon. Both types of emulsions require appropriate surfactants to form stable emulsions of the desired droplet size distribution. The term “stable” emulsion is recognized in the art as meaning an emulsion wherein the dispersed phase remains dispersed. For example, a stable water-in-hydrocarbon emulsion means water droplets are dispersed in a hydrocarbon phase and the water droplets remain dispersed without coalescing and phase separating. If the average droplet sizes of the dispersed phase are less than about 1 micron in size, the emulsions are generally termed micro-emulsions. If the average droplet sizes of the dispersed phase droplets are greater than about 1 micron in size, the emulsions are generally termed macro-emulsions. A hydrocarbon-in-water macro or micro emulsion has water as the continuous phase. A water-in-hydrocarbon macro or micro emulsion has hydrocarbon as the continuous phase.

The hydrocarbon component of the first mixture, the second mixture and the product water-in-hydrocarbon emulsion resulting from the mixing of the first and second mixtures is any hydrocarbon boiling in the range of 30° F. (−1.1° C.) to 500° F. (260° C.), preferably 50° F. (10° C.) to 380° F. (193° C.) with a sulfur content less than about 120 ppm and more preferably with a sulfur content less than 20 ppm and most preferably with a no sulfur. Hydrocarbons suitable for the emulsion can be obtained from crude oil refining processes known to the skilled artisan. Low sulfur gasoline, naphtha, diesel fuel, jet fuel, kerosene are non-limiting examples of hydrocarbons that can be utilized to prepare the emulsion of the instant invention. A Fisher-Tropsch derived paraffin fuel boiling in the range between 30° F. (−1.1° C.) and 700° F. (371° C.) and, more preferably, a naphtha comprising C5-C10 hydrocarbons can also be used.

The hydrocarbon component of the first mixture, the second mixture and the product water-in-hydrocarbon emulsion resulting from the mixing of the first and second mixtures is water that is substantially free of salts of halides sulfates and carbonates of Group I and Group II elements. Distilled and deionoized water is suitable. Water generated from the operation of the fuel cell system is preferred. Water-alcohol mixtures can also be used. Low molecular weight alcohols selected from the group consisting of methanol, ethanol, normal and iso-propanol, normal, iso and secondary-butanol, ethylene glycol, propylene glycol, butylene glycol and mixtures thereof are preferred. The ratio of water:alcohol can vary from about 99.1:0.1 to about 20:80, preferably 90:10 to 70:30.

A component of the product water-in-hydrocarbon emulsion composition that is used in the fuel cell reformer is an alkoxylated branched alkyl alcohol surfactant and mixtures thereof, represented by the formula
R—O—(M-O)ₙ—H
wherein R is an branched alkyl group of 6 to 26 carbons,
n is an integer from about 1 to 50,
M is CH₂—CH₂, CH₂—CH₂—CH₂, CH₂—CH—CH₃, CH₂—CH₂—CH₂—CH₂, CH₂—CH—(CH₃)—CH₂ or mixtures thereof.

For preparation of the first mixture of hydrocarbon-in-water emulsion and excess hydrocarbon the preferred surfactant is represented by the formula
R—O—(M-O)ₙ—H
wherein R is an branched alkyl group of 6 to 26 carbons,
n is an integer from about 8 to 50,
M is CH₂—CH₂, CH₂—CH₂—CH₂, CH₂—CH—CH₃, CH₂—CH₂—CH₂—CH₂, CH₂—CH—(CH₃)—CH₂ or mixtures thereof. The preferred surfactant is preferably soluble in the water phase.

For preparation of the second mixture of water-in-hydrocarbon emulsion and excess water the preferred surfactant is represented by the formula
R—O—(M-O)ₙ—H
wherein R is an branched alkyl group of 6 to 26 carbons,
n is an integer from about 1 to 7,
M is CH₂—CH₂, CH₂—CH₂—CH₂, CH₂—CH—CH₃, CH₂—CH₂—CH₂—CH₂, CH₂—CH—(CH₃)—CH₂ or mixtures thereof. The preferred surfactant is preferably soluble in the hydrocarbon phase.

In the preferred surfactants for the first and second mixture, preferably M is CH₂—CH₂. Branched alkyl groups are essentially non-linear hydrocarbon chain structures comprising methyl, ethyl, isopropyl, n-butyl, sec-butyl, tertiary butyl groups and mixtures thereof. The term “alkyl” in the alkoxylated branched alkyl alcohol surfactant is meant to represent branched saturated alkyl hydrocarbons, branched unsaturated alkyl hydrocarbons and mixtures thereof. The preferred surfactants are thermally labile and decompose to the extent that at about 700° C. substantially all of the surfactant is decomposed.

The total concentration of surfactant in the first mixture is in the range of 0.01 to 2.5 wt % based on the weight of hydrocarbon comprising the mixture. The ratio of hydrocarbon:water in the first mixture can vary from 40:60 to 60:40 based on the weight of the hydrocarbon and water. In terms of the ratio of water molecule:carbon atom in the emulsion, the ratio can be 0.5 to 3.0. A ratio of water molecule:carbon atom of 0.9 to 1.5 is preferred. The total concentration of surfactant in the second mixture is in the range of 0.005 to 5-wt % based on the weight of hydrocarbon comprising the mixture. The ratio of hydrocarbon: water in the second mixture can vary from 40:60 to 60:40 based on the weight of the hydrocarbon and water. In terms of the ratio of water molecule:carbon atom in the emulsion, the ratio can be 0.5 to 3.0. A ratio of water molecule: carbon atom of 0.9 to 1.5 is preferred.

It is preferred to store the surfactants to prepare the first and the second mixtures of the instant invention as a concentrate in the start-up system. The surfactant concentrate can comprise the said surfactant or mixtures of said surfactants and hydrocarbon. Alternately, the surfactant concentrate can comprise the said surfactant or mixtures of said surfactants and water. The amount of surfactant can vary in the range of about 80% surfactant to about 30 wt %, based on the weight of the hydrocarbon or water. Optionally, the surfactant concentrate can comprise the said surfactant or mixtures of said surfactants and a water-alcohol solvent. The amount of surfactants can vary in the range of about 80 wt % to about 30 wt %, based on the weight of the water-alcohol solvent. The ratio of water:alcohol in the solvent can vary from about 99:1 to about 1:99. The hydrocarbon, water and alcohol used for storage of the surfactant concentrate are preferably those that comprise the mixture and described in the preceding paragraphs.

Preferably the preparation of the first mixture and second mixture and the mixing of the first and second mixture are conducted at low shear. Low shear mixing can be mixing in the shear rate range of 1 to 50 sec⁻¹, or expressed in terms of mixing energy, in the mixing energy range of 0.15×10⁻⁵ to 0.15×10⁻³ kW/liter of fluid. Mixing energy can be calculated by one skilled in the art of mixing fluids. The power of the mixing source, the volume of fluid to be mixed and the time of mixing are some of the parameters used in the calculation of mixing energy. In-line mixers, low shear static mixers, low energy sonicators are some non-limiting examples for means to provide low shear mixing.

A method to prepare the first mixture of the instant invention comprises the steps of adding surfactant to the water phase, adding the said surfactant solution to hydrocarbon and mixing at a shear rate in the range of 1 to 50 sec⁻¹ (0.15×10⁻⁵ to 0.15×10⁻³ kW/liter of water plus hydrocarbon fluid) for 1 second to 15 minutes to form the first mixture. A method to prepare the second mixture of the instant invention comprises the steps of adding surfactant to the hydrocarbon phase, adding the said surfactant solution to water and mixing at a shear rate in the range of 1 to 50 sec⁻¹ (0.15×10⁻⁵ to 0.15×10⁻³ kW/liter of water plus hydrocarbon fluid) for 1 second to 15 minutes to form the second mixture.

Another method to form the first and second mixture comprises adding the appropriate surfactants to the hydrocarbon and water mixture followed by mixing. A method to prepare the product water-in-hydrocarbon emulsion of the instant invention comprises forming the first and second mixtures as described and then adding the first mixture of hydrocarbon-in-water emulsion and excess hydrocarbon to the second mixture of water-in-hydrocarbon and excess water and mixing. Low shear mixing is preferred. Preferably mixing at a shear rate in the range of 1 to 50 sec⁻¹ (0.15×10⁻⁵ to 0.15×10⁻³ kW/liter of water plus hydrocarbon fluid) for 1 second to 30 minutes, preferably 1 second to 15 minutes and more preferably 1 second to 5 minutes.

When alkoxylated branched alkyl alcohols of the instant invention are added to naphtha and distilled water and subject to low shear mixing one can form the first and second mixture. For formation of the first mixture and second mixtures of the instant invention substitution of water with water/methanol mixture in the ratio of 80/20 to 60/40 does not alter the emulsifying performance of the surfactants or the process of forming the water-in-hydrocarbon.

In a preferred embodiment, the reformer of the fuel cell system is started with the product water-in-hydrocarbon emulsion wherein the emulsion made by mixing two mixtures: a first mixture of hydrocarbon-in-water emulsion and excess hydrocarbon with second mixture of water-in-hydrocarbon emulsion and excess water. In the operation of the fuel cell it is expected that the product water-in-hydrocarbon emulsion composition will be utilized at start-up of the reformer and extending for a time period when a switch to hydrocarbon and steam is made. One embodiment of the invention is the feeding to the reformer of a fuel cell system, first a composition comprising the product water-in-hydrocarbon emulsion composition of the instant invention, followed by a hydrocarbon/steam composition. The product water-in-hydrocarbon emulsion composition allows a smooth transition to the hydrocarbon/steam composition.

The following non-limiting examples illustrate the invention.

### EXAMPLE 1

A first mixture of hydrocarbon-in-water emulsion and excess hydrocarbon was prepared by adding 0.03 g of polyethylene glycol (8) branched dodecanol (sold by ExxonMobil Chemical Company, as Exxal 12-8 wherein 12 denotes the carbon chain number and 8 denotes the number of CH₂—CH₂—O ethoxylate groups) to a mixture of 5.0 g naphtha (dyed orange) and 5.0 g water (dyed blue) and mixed using a Fisher Hemetology/Chemistry Mixer Model 346. Mixing was conducted for 5 minutes at 25° C.

A second mixture of water-in-hydrocarbon emulsion and excess water was prepared by adding 0.03 g of polyethylene glycol (4) branched dodecanol (sold by ExxonMobil Chemical Company, as Exxal 12-4 wherein 12 denotes the carbon chain number and 4 denotes the number of CH₂—CH₂—O ethoxylate groups) to a mixture of 5.0 g naphtha (dyed orange) and 5.0 g water (dyed blue) and mixed using a Fisher Hemetology/Chemistry Mixer Model 346. Mixing was conducted for 5 minutes at 25° C.

Next the entire first mixture was added to the entire second mixture and mixed using a Fisher Hemetology/Chemistry Mixer Model 346. Mixing was conducted for 5 minutes at 25° C. The resultant product was characterized as a product water-in-hydrocarbon emulsion.

Conductivity measurements are ideally suited to determine the phase continuity of an emulsion. A water continuous emulsion will have conductivity typical of the water phase. A hydrocarbon continuous emulsion will have negligible conductivity. By using dyes to color the hydrocarbon and water, optical microscopy enables determination of the type of emulsions by direct observation.

Using a Leitz optical microscope the emulsion of example 1 was characterized as a water-in-hydrocarbon macro type emulsion. The conductivity of water was recorded as 47 micro mho; naphtha as 0.1 micro mho and the emulsion of example 1 was 5 micro mho confirming the water-in-hydrocarbon emulsion characteristics of the product water-in-hydrocarbon emulsion.

Using the product water-in-hydrocarbon emulsion prepared by the process disclosed in the instant application has reformer performance advantages and enhancements compared to using emulsions of hydrocarbon and water in the absence of stabilizing surfactants as disclosed in U.S. Pat. No. 5,827,496 and is a further improvement to the bicontinuous emulsion disclosed in U.S. Pat. No. 6,736,867 and U.S. Pat. No. 7,081,143.

### EXAMPLE 2

To contrast the method of the instant invention with that of the prior art method of adding surfactant to a mixture of hydrocarbon and water and mixing the following experiments were conducted.

To a mixture of 5.0 g naphtha (dyed orange) and 5.0 g water (dyed blue) was added 0.06 g of polyethylene glycol (8) branched dodecanol (sold by ExxonMobil Chemical Company, as Exxal 12-8 wherein 12 denotes the carbon chain number and 8 denotes the number of CH2—CH2—O ethoxylate groups) and 0.06 g of polyethylene glycol (4) branched dodecanol (sold by ExxonMobil Chemical Company, as Exxal 12-4 wherein 12 denotes the carbon chain number and 4 denotes the number of CH2—CH2—O ethoxylate groups) and mixed using a Fisher Hemetology/Chemistry Mixer Model 346. Two hours of mixing at 25° C. was required to form a water-in-hydrocarbon emulsion without phase separated water or hydrocarbon. Lesser amounts of surfactant, i.e., 0.04 g each of Exxal 12-4 and Exxal 12-8 and 0.05 g each of Exxal 12-4 and Exxal 12-8 were insufficient to form water-in-hydrocarbon emulsion without phase separated water or hydrocarbon. The results of these experiments show that at least about twice the amount of surfactant and longer times are required to form water-in-hydrocarbon emulsion without phase separated water or hydrocarbon compared to the method of the instant invention.

What is claimed is:

1. A stable water-in-hydrocarbon emulsion made by the process comprising:
a) preparing a first mixture of hydrocarbon-in-water emulsion and excess hydrocarbon,
b) preparing a second mixture of water-in-hydrocarbon emulsion and excess water,
c) adding the said first mixture of hydrocarbon-in-water emulsion and excess hydrocarbon to said second mixture of water-in-hydrocarbon emulsion and excess water and then mixing said first and second mixtures to form the said product water-in-hydrocarbon emulsion.

2. The improvement of claim 1 wherein said first mixture of hydrocarbon-in-water emulsion and excess hydrocarbon comprises:
at least 50 wt % of hydrocarbon,
from 30 to 50 wt % of water, and
from 0.005 to 5 wt % of an alkoxylated branched alkyl alcohol surfactant and mixtures thereof, represented by the formula
R—O—(M-O)ₙ—H
wherein R is a branched alkyl group of 6 to 26 carbons,
n is an integer from about 8 to 50,
M is CH₂—CH₂, CH₂—CH₂—CH₂, CH₂—CH—CH₃, CH₂—CH₂—CH₂—CH₂, CH₂—CH—(CH₃)—CH₂ or mixtures thereof.

3. The improvement of claim 1 wherein said second mixture of water-in-hydrocarbon emulsion and excess water comprises:
at least 50 wt % of hydrocarbon,
from 30 to 50 wt % of water, and
from 0.005 to 5 wt % of an alkoxylated branched alkyl alcohol surfactant and mixtures thereof, represented by the formula
R—O—(M-O)ₙ—H
wherein R is a branched alkyl group of 6 to 26 carbons,
n is an integer from about 1 to 7,
M is CH₂—CH₂, CH₂—CH₂—CH₂, CH₂—CH—CH₃, CH₂—CH₂—CH₂—CH₂, CH₂—CH—(CH₃)—CH₂ or mixtures thereof.

4. The improvement of claim 1 wherein said product water-in-hydrocarbon emulsion comprises:
at least 50 wt % of hydrocarbon,
from 30 to 50 wt % of water, and
from 0.01 to 10.0 wt % of an alkoxylated branched alkyl alcohol surfactant
and mixtures thereof, represented by the formula
R—O—(M-O)ₙ—H
wherein R is a branched alkyl group of 6 to 26 carbons,
n is an integer from about 1 to 50,
M is CH₂—CH₂, CH₂—CH₂—CH₂, CH₂—CH—CH₃, CH₂—CH₂—CH₂—CH₂, CH₂—CH—(CH₃)—CH₂ or mixtures thereof.

5. The improvement of claim 1 wherein the product water-in-hydrocarbon emulsion further comprises up to 20 wt % alcohol based on the total weight of the said emulsion wherein said alcohol is selected form the group consisting of methanol, ethanol, n-propanol, iso-proponal, n-butanol, sec-butyl alcohol, tertiary butyl alcohol, n-pentanol, ethylene gylcol, propylene glycol, butyleneglycol and mixtures thereof.

6. The improvement of claims 2, 3 or 4 wherein said hydrocarbon is in the boiling range of −1° C. to 260° C.

7. The improvement of claims 2, 3 or 4 wherein said water is substantially free of metal salts.

8. The improvement of claim 1 wherein the product water-in hydrocarbon emulsion is a macro emulsion.

9. The improvement of claims 2, 3 or 4 wherein said surfactant thermally decomposes at temperatures below about 700° C.

10. The improvement of claims 2, 3 or 4 wherein in said surfactant M is CH₂—CH₂.

11. A method to prepare a product water-in-hydrocarbon emulsion comprising:
a) preparing a first mixture of hydrocarbon-in-water emulsion and excess hydrocarbon,
b) preparing a second mixture of water-in-hydrocarbon emulsion and excess water,
c) adding the said first mixture of hydrocarbon-in-water emulsion and excess hydrocarbon to said second mixture of water-in-hydrocarbon emulsion and excess water and then mixing said first and second mixtures to form the said product water-in-hydrocarbon emulsion.

12. The method of claim 11 wherein said mixing is mixing in the mixing energy in the range of 0.15×10⁻⁵ to 0.15×10⁻³ kW/liter of product water-in-hydrocarbon emulsion.

13. The method of claim 11 wherein said product water-in-hydrocarbon emulsion comprises:
at least 50 wt % of hydrocarbon,
from 30 to 50 wt % of water, and
from 0.01 to 10 wt % of an alkoxylated branched alkyl alcohol surfactant and mixtures thereof, represented by the formula
R—O—(M-O)ₙ—H
wherein R is a branched alkyl group of 6 to 26 carbons,
n is an integer from about 2 to 50,
M is CH₂—CH₂, CH₂—CH₂—CH₂, CH₂—CH—CH₃, CH₂—CH₂—CH₂—CH₂, CH₂—CH—(CH₃)—CH₂ or mixtures thereof.

14. The method of claim 11 wherein mixing is conducted by an in-line mixer, static paddle mixer, sonicator or combinations thereof.

15. The method of claim 11 wherein said mixing is conducted for a time period in the range of 1 second to about 15 minutes.
